(19) United States
(12) Patent Application Publication
(10) Pub. No.: US 2017/0017700 A1
(43) Pub. Date: Jan. 19, 2017

(54) CREATING A DYNAMIC VISUAL DISPLAY OF SOCIAL NETWORK ACTIVITY

(71) Applicant: International Business Machines Corporation, Armonk, NY (US)

(72) Inventor: Mudit Mehrotra, New Delhi (IN)

(21) Appl. No.: 14/802,399

(22) Filed: Jul. 17, 2015

(51) Int. Cl. G06F 17/30; H04L 29/08; H04L 12/58

(52) U.S. Cl. CPC G06F 17/30554; H04L 51/32; H04L 51/16; H04L 67/22

(57) ABSTRACT

In an approach to create a visual replay of one or more activities occurring in a user's social network, a computer receives a command to create a file for a dynamic visual replay of one or more activities occurring in the user's social network, where the one or more activities occur while the user is logged off the social network. The approach includes the computer retrieving the one or more activities occurring while the user is logged off the social network and creating the file for the dynamic visual replay of the one or more activities occurring while the user is logged off the social network.

### BACKGROUND OF THE INVENTION

The present invention relates generally to the field of online social networking and more particularly to creating a file for a dynamic visual replay of activities occurring in a user's online social network while the user is logged off the social network.

Social media is used by millions of users across the globe as it expedites conversations relative to real-time current events in traditional media and permits users to instantly obtain and share information. Social networks are a source or a type of social media conventionally provided using an online site, service, or platform through which individuals, organizations, or communities create, organize, and share information or other content. Social network service (SNS) or social network providers such as Facebook®, LinkedIn®, and Twitter® provide the infrastructure, including platforms, applications, code, and data storage structure that allows individuals to create user profiles representing the user. Most social networks create individually tailored user social networks of friends, acquaintances, and colleagues to establish, and maintain connections, relationships, and communications with other individuals, users, or groups who may share interests, activities, backgrounds, or real-life connections. Social networks may allow the user to create categories or groups of people, co-workers, classmates, club members, or friends for sharing of specified information, messages, posts, photographs, videos, or other type of communications.

Social networks permit users to post information about themselves and to communication with other people, e.g., their friends, family, classmates, and co-workers. Activities in a social network may include but are not limited to sharing an uploaded photograph or video, a link or links, a status on the user's current location or current activities, a post, a “like” or other opinion on a comment, photograph, product, or other event, and sending a message to an individual or a group.

### SUMMARY

Embodiments of the present invention disclose a method, a computer program product, and a system for creating a visual replay of one or more activities occurring in a user's social network. The method includes a computer receiving a command to create a file for a dynamic visual replay of one or more activities occurring in a user's social network, where the one or more activities occur while the user is logged off the social network. Additionally, the method includes the computer retrieving the one or more activities occurring while the user is logged off the social network and creating the file for the dynamic visual replay of the one or more activities occurring while the user is logged off the social network.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a visual transformation program, on a server computer within the distributed data processing environment of FIG. 1, for creating a file for a dynamic visual display or video replay of a user's social network account activity while a user is logged off the social network, in accordance with an embodiment of the present invention; and

FIG. 3 depicts a block diagram of components of a computer system, which is an example of a system such as the server within the distributed data processing environment of FIG. 1, in accordance with an embodiment of the present invention.

### DETAILED DESCRIPTION

Embodiments of the present invention recognize that social network services provide a user a static timeline of some of the activities or events that occur on a user's account when the user has logged off for a period of time. Social network services do not provide a unified view of the complete sequence of events or activities that have occurred. For example, a user may see that another user “liked” a picture while the user was logged off but may not know if the other user “liked” the picture before “liking” the comment by the user's boss.

Embodiments of the present invention provide a transformation of stored account log records of the activities occurring in a user's social network when the user is logged off the social network into a format or file for a dynamic visual or video replay of the stored activities. Embodiments of the present invention create a visual media file for a full spectrum review and a sequential record of each activity and each event such as likes, posts, messages, shared links, and other user account activity in the order received. The dynamic visual replay or video replay creates a “real-time” experience of the activities occurring in the user's social network while the user is logged off the social network.

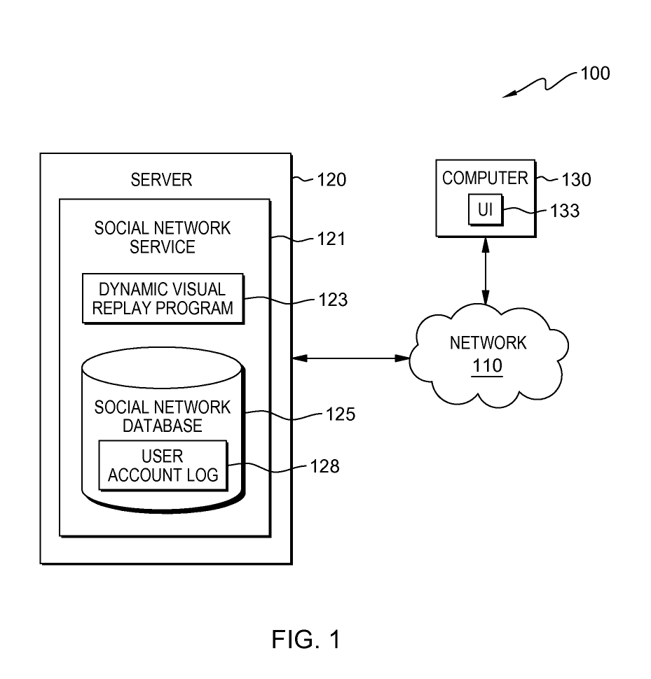

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 120, and computer 130, all interconnected over network 110. Network 110 can include, for example, a telecommunications network, a local area network (LAN), a virtual LAN (VLAN), a wide area network (WAN), such as the Internet, or a combination of the these, and can include wired or wireless connections. Network 110 can include one or more wired and/or wireless networks that are capable of receiving and transmitting data, voice, and/or video signals, including multimedia signals that include voice, data, and video information. In general, network 110 can be any combination of connections and protocols that will support communications between server 120, computer 130 and other computing devices (not shown) within distributed data processing environment 100.

Server 120 can be a web server, a management server, a standalone computing device, a desktop computer, a notebook, a tablet, a mobile computing device, or any other electronic device or computing system capable of receiving, sending, and processing data. In an embodiment, server 120 can be a web server, a server system, a laptop computer, a personal computer (PC), a desktop computer, a mobile computing device, or any programmable electronic device capable of communicating with computer 130, and other computing devices (not shown) via network 110. In another embodiment, server 120 represents a computing system or a server system such as used in a cloud-computing environment utilizing clustered computers and components (e.g., database server computers, application server computers, etc.) that act as a single pool of seamless resources when accessed within distributed data processing environment 100. Server 120 includes social network service 121, dynamic visual replay program 123, social network database 125, and user account log 128.

Social network service (SNS) 121 on server 120 is an online social networking service provider. SNS 121 may be any social networking service or social network provider. For example, SNS 121 may include but, is not limited to Facebook®, Twitter®, Instagram®, LinkedIn®, XING®, or any social network service not listed developed for online or mobile social networking. SNS 121 provides a social networking service to build social network relationships between users or clients. For example, clients or users of SNS 121 may create user profiles, social links such as “friends”, groups, and connections within the social network, and may provide the ability to create groups of users, share connections, and communicate over the internet by e-mail or instant messaging. In addition, SNS 121 can incorporate various communication tools such as mobile connectivity, blogging, photograph and video sharing, and other social networking features and capabilities known to one skilled in the art. SNS 121 captures and sends the activities (e.g., posts, likes, friend requests, and shared links) occurring within a user's social network account and among the user's social network connections to user account log 128 for storage.

In various embodiments, SNS 121 sends data such as a file, a notification, or a record for each activity occurring in the user's social network while the user is logged off to user account log 128 in social network database 125. In one embodiment, dynamic visual replay program 123 sends a command to SNS 121 to format each received user account activity in a discreet file for display including links, and other associated data. In one embodiment, SNS 121 formats for display the discreet file of an activity occurring in the logged off user's SNS 121 social network. For example, SNS 121 would format each of the received user account activities as a file for display or as it would for a real-time display to the user. In this example, SNS 121 sends the formatted, discreet static file to user account log 128 with a timestamp on receipt of the data or activity in the user's social network. In one embodiment, SNS 121 sends a discreet file for each activity occurring in the user's social network while the user is logged off SNS 121 to dynamic visual replay program 123. In this embodiment, the discreet file may be formatted for display or may be unformatted (e.g., just the static discreet file of the activity occurring in the logged off user's social network in SNS 121). In another embodiment, SNS 121 upon receiving from dynamic visual replay program 123 a command initiating a data stream or a real-time feed of the user account activities received by SNS 121 sends the data stream or real-time feed to dynamic visual replay program 123.

Social network service (SNS) 121 includes dynamic visual replay program 123, and social network database 125 with user account log 128. While depicted on server 120 in FIG. 1, one or all of these applications, platforms, or programs may reside on another computing device or on multiple computing devices with access to each other for operation of the invention via network 110.

Dynamic visual replay program 123 is code and routines of a program providing the capability to create a file for a dynamic visual display of user account activity while the user is logged off of SNS 121. For the purposes of the present invention, a user who is logged off of SNS 121 or logged off SNS 121 is not signed on to his or her social network account on SNS 121, however, they may or may not be online in an e-mail account, in another application in another program, may not be actively using a computing device, or may not have a computer device powered up or turned on.

A dynamic visual display or replay is a moving display or replay of captured events, activities, or actions occurring in an environment that can be viewed or seen in a dynamic or moving visual format such as a video, a screencast, a screen recording, a screen show, a movie, or other visual media capable of displaying a moving visual replay of captured events. Dynamic visual replay program 123 creates a file such as a visual media file, a video file, a screencast file, a screen recorder file, a screen show, a movie, or another type of file for a dynamic visual review of the activities that occur in the user's social network while the user is logged off SNS 121. A screencast is a digital recording of a computer screen output.

In various embodiments, dynamic visual replay program 123 creates a file for a dynamic visual replay by retrieving from user account log 128, a file or a discreet file for each activity occurring in a user's social network, formatting each of the retrieved files for display, and compiling each of the retrieved files, in chronological order, in a file for the dynamic visual display (e.g., in a screen show or a video). In another embodiment, SNS 121 is configured to provide to dynamic visual replay program 123 a real-time feed of activities occurring in a logged off user's social network. The compiled file such as a screen show, a screen recording, a video, or another type of dynamic (moving) display of the logged off user's social network activities is sent by dynamic visual replay program 123 to computer 130 for display to the user on UI 133. The created file allows the user to view the full context, timing, and series of events and activities in the sequence the activities would have been seen if the user was logged on SNS 121. In an embodiment, dynamic visual replay program 123 resides on another server, another computing device, or multiple computing devices. In one embodiment, dynamic visual replay program 123 resides on computer 130.

In some embodiments, the file created by dynamic visual replay program 123 displays the time and date when the activity occurred in a portion of the displayed file. For example, the time an activity is received by SNS 121 may be formatted or added by dynamic visual replay program 123 to be the dynamically displayed file in the right upper corner, right lower corner, another location in the dynamic visual replay, as a pop-up, displayed in a scrollbar, or other known display method for showing when an activity occurred. In an embodiment, dynamic visual replay program 123 resides on another server, another computing device, or multiple computing devices. In one embodiment, dynamic visual replay program 123 resides on computer 130.

Social network database 125 stores data, posts, messages, shared links, files such as uploaded photographs, video files, text, other forms of electronic data or online communications within SNS 121. Social network database 125 receives and stores data from SNS 121, dynamic visual replay program 123, computer 130, and other computing devices (not depicted in FIG. 1). While social network database 125 resides on server 120 in the embodiment depicted in FIG. 1, social network database 125 may be included in one more computing devices, servers, database servers, or stored in a cloud-computing environment.

User account log 128 stores data and files received from the user's account in SNS 121. User account log 128 may receive and store data or records such as posts, messages, likes, uploaded photographs, video files, links, and another known information shared on SNS 121 with members of the user's social network. User account log 128 is capable of receiving and storing data from dynamic visual replay program 123, computer 130, SNS 121, and other computing devices (not shown in FIG. 1). The stored data and records in user account log 128 of the activities occurring within the user's social network include a timestamp, marker, a flag, or other indicator of the date and time the data and record of the activity was received by SNS 121 when the user is logged off SNS 121. The user account activities or user's social network activities are received and stored by user account log 128. User account log 128 includes a marker, a flag, or another similar known identifier in the user account log file provided by SNS 121 when the user logs off SNS 121. In various embodiments, user account log 128 receives and stores each user account activity received from SNS 121 as a discreet file or record. In an embodiment, user account log 128 receives and stores the user account activities as a dynamic, continuous record or file such as a screencast, a video, or other dynamic visual media file from dynamic visual replay program 123. While depicted on server 120 in SNS 121, user account log 128 may reside on another server, another computing device, or on multiple computing devices. In one embodiment, user account log 128 resides on computer 130.

Computer 130 is a computing device, a desktop computer, a smart phone, a smart watch, a personal digital assistant, a wearable computer, a tablet computer, a laptop computer, a hand-held computing device, a specialized computer device, or any programmable electronic device capable of communicating with various components and devices within distributed data processing environment 100 via network 110. Wearable computers are miniature electronic devices that may be worn by the bearer under, with, or on top of clothing, as well as glasses, watches, hats, or other accessories. Computer 130 includes UI 133 that may be used for displaying the files created by dynamic visual replay program 123. In one embodiment, computer 130 includes dynamic visual replay program 123. While only computer 130 is depicted in FIG. 1, as one skilled in the art understands, many multiple computing devices including multiple smart phones or other portable electronic devices or computing devices (not shown in FIG. 1) may be present in distributed data processing environment 100. Computer 130 is connected via network 110 to server 120, SNS 121 and other computing devices (not shown in FIG. 1) via network 110. In various embodiments, computer 130 receives from dynamic visual replay program 123 the created file of the user account activity for a dynamic visual display on UI 133 of the account activities such as a video of the user account activity in SNS 121 when the user is logged off. In general, computer 130 represents any programmable electronic device or combination of programmable electronic devices capable of executing machine readable program instructions and communicating with server 120 and other computing devices (not shown) within distributed data processing environment 100 via network 110.

UI 133 provides an interface between a user and computer 130. UI 133 may be a graphical user interface (GUI) or a web user interface (WUI) and can access application interfaces, display text, documents, web browser windows, user options, and instructions for operation, and includes the information (such as graphic, text, and sound) that a program presents to a user and the control sequences the user employs to interact with computer 130. UI 133 provides the capability commonly provided by a UI or a GUI to display dynamic visual media such as a video, a movie, or other form of dynamic visual media. For example, UI 133 may be used to display to the user the one or more files created by dynamic visual replay program 123 of the activities received in the user's social network while the user is logged off SNS 121. UI 133 provides the capability to display a screencast, video, a screen recording, a movie, or other visual media file for a dynamic (e.g., moving) display of user account activity and includes known methods to pause, stop, fast forward, slow motion replay, or other similar functions for use in the displayed file. UI 133 may also be mobile application software that provides an interface between a user and computer 130 when computer 130 is a mobile computing device. Mobile application software, or an “app,” is a computer program designed to run on smart phones, tablet computers and other mobile devices. UI 133 enables a user of computer 130 to communicate data, queries, commands, files or other electronic information to SNS 121, dynamic visual replay program 123, and social network database 125 on server 120 and to other computing devices (not shown) in distributed data processing environment 100.

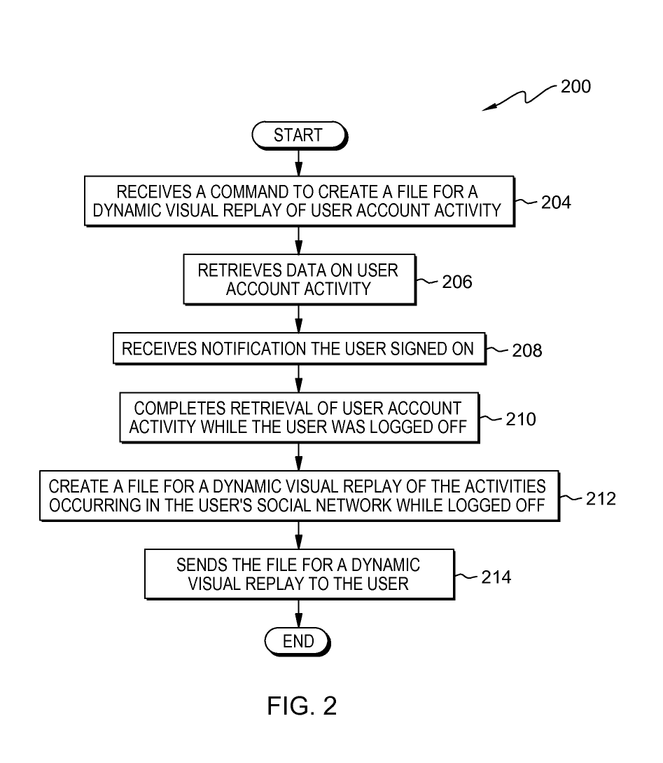

FIG. 2 is a flowchart 200 depicting operational steps of dynamic visual replay program 123, on server 120 within distributed data processing environment 100, for creating a file for a dynamic visual display or video replay of a user's social network account activity while a user is logged off the social network, in accordance with an embodiment of the present invention.

Dynamic visual replay program 123 receives a command to create a file for a dynamic visual replay of user account activity (204). Dynamic visual replay program 123 receives a command to create a file for a dynamic visual replay or display of the activity occurring in a user's social network when the user is logged off SNS 121. The command received by dynamic visual replay program 123 can be generated by one of the following methods: by a user selection in SNS 121, by user preference configured in SNS 121, or a configured default setting in SNS 121 initiating dynamic visual replay program 123 when a user signs off.

In an embodiment, dynamic visual replay program 123 is initiated upon receiving from UI 133 a user selection in SNS 121 to create a file for a dynamic visual replay of the activity and events occurring in the user's social network account while the use is logged off SNS 121. In various embodiments, the user selection occurs when the user logs off SNS 121. For example, a menu selection such as a pull down menu selection, an icon, a button, or another user selection method for a dynamic visual review (e.g., video) of the user's social network activity while logged off may be provided when the user logs off SNS 121. In one embodiment, the user may request dynamic visual replay program 123 to provide a dynamic visual display or video review of account activity while logging on SNS 121 from an active input line, an icon, a pull down screen or other user selection method from another location in SNS 121.

In an embodiment, dynamic visual replay program 123 user selection includes a choice of receiving a selective or condensed dynamic display of the logged off user social network activities (e.g., a display of user account activities in the order received without the non-active time or a dynamic visual replay condensed, displaying only the user account activities) or a complete, continuous display of user account activities (e.g., including non-active user account time when no user activities are received). For example, the continuous dynamic display or replay would display the user social network activities as if they were logged on when they were received (e.g., a “real-time” like review of user account activities received when logged off including inactive user account time). The continuous display of real-time like user account activity may include markers, flags, or timestamps for each received activity to assist fast forwarding, moving, or jumping to the next activity. In an embodiment, dynamic visual replay program 123 provides the user the ability to fast forward, move, or jump to the next activity occurring in the dynamic visual replay using a button, a bar, an icon, or another method to move between markers, flags, or timestamps. In one embodiment, dynamic visual replay program 123 provides the ability to select a portion of the file created using the timestamps for received user activities. For example, a user may only want to review the activity that occurred between 6 pm and 10 pm on April 12.

In one embodiment, dynamic visual replay program 123 receives a request or a command from a logged off user (e.g., the user is already logged off SNS 121) for the creation of a video or file created for a dynamic visual replay of the activities occurring in the logged off user's social network. For example, a user not currently logged on SNS 121 and not in the process of logging on SNS 121 inputs on UI 133 a command to dynamic visual replay program 123 requesting the creation of a file to replay or dynamically display the activities occurring in the user's social network. In this example, the user may need to provide to SNS 121 a password, user account password, or other identification.

In another embodiment, dynamic visual replay program 123 is initiated by a user who is logged on SNS 121. Dynamic visual replay program 123 may be initiated, for example, by a command such as “initiate dynamic visual replay program” from the command line, from an icon, a pull down menu, or other user selection method when a user is active in another application or program (e.g., playing an online game or in an online meeting).

In one embodiment, the user selects a user preference for a default selection of dynamic visual replay program 123 in SNS 121. For example, when a user joins SNS 121 and sets up a user profile, SNS 121 may inquire if the user would like to be provided with a video of the activities occurring in the user's social network when they log off SNS 121. The user may select to set a user preference to receive when the user logs on a dynamic visual replay such as a video from dynamic visual replay program 123 of missed user account activity while the user is logged off of SNS 121. In an embodiment, the user preference for receiving a dynamic visual replay or video of missed user account activities can be changed at any time in the user profile. In another embodiment, dynamic visual replay program 123 is configured as a default in SNS 121 and is automatically initiated when a user signs off their account on SNS 121.

In an embodiment, dynamic visual replay program 123 creates a file for a video or dynamic visual replay of the activities occurring in their social network received from a user or a user group (e.g., a golf league or a group of friends configured in the user's account on SNS 121). For example, when a user selects a command to request the creation of a file a dynamic visual replay or a video of the activities occurring in user's social network when the user is logged off SNS 121, the user may additionally, or instead request to create a file for a dynamic visual replay or video of the activities occurring in the logged off user's social network that originate or are from a specific user or a specific group of users such as “Monday golf league”. In this example, an icon, a button, or a command may be selected by the user from the screen used to request a video or dynamic visual replay. The icon, button, or command such as “provide replay for a group” or “provide a replay for a contact” may entered and in response, dynamic visual replay program 123 may retrieve a list of user groups and/or a list of user names from the user profile or user's account in social network database 125 or in persistent storage 308. The user may select a group of user's or a specific user to a request or to send a command to dynamic visual replay program 123 to receive a file for a video or dynamic visual replay of the activities received from the selected user or group of users while the user is logged off SNS 121.

In the exemplary embodiment, upon receiving the request to initiate dynamic visual replay program 123 from the user on computer 130 via network 110, dynamic visual replay program 123 retrieves the data on user account activity (206). In various embodiments, dynamic visual replay program 123 retrieves stored user account activity from user account log 128 in social network database 125 for the account activities occurring when the user signs off the social network. The retrieved data includes user account log activity for SNS 121 such as communications related to or for the user's social network account including but not limited to likes, posts, e-mails, messages, shared links, photographs, videos, and group messages specific to the user's social network account.

In various embodiments, dynamic visual replay program 123 retrieves the user account data on a set schedule. For example, dynamic visual replay program 123 may be pre-configured or set to a default retrieval time such as to retrieve user account activity from user account log 128 every ten minutes. In another embodiment, dynamic visual replay program 123 is configured by the user to retrieve the user account data on the activities occurring when the user is logged off SNS 121 according to the user determined schedule or time. For example, when the user initiates dynamic visual replay program 123, an icon, a pop up, a pull down menu item may be selected by the user to set a time or schedule for data retrieval, or a user input a command such as “set account log data retrieval for every 30 minutes” from an active command line to set the schedule for data retrieval. In various embodiments, the retrieved data from user account log 128 is in a discreet or static file form for each user account activity. For example, dynamic visual replay program 123 retrieves from user account log 128 data (e.g., file or record) of the activities that occurred or were sent to the user's social network account by other members of the user's social network such as friends who posted likes, comments, messages, photographs and shared links with the user while the user was logged off SNS 121. Each user account activity (i.e., each post, each shared link, each like, or other user account activity) is retrieved from user account log 128 as a discreet log entry, record, or file with a timestamp of receipt by SNS 121.

In another embodiment, dynamic visual replay program 123 generates a command to receive a real-time feed of the user's social network account activities. In response to a user selection of a continuous dynamic replay of logged off user account activities; dynamic visual replay program 123 receives from SNS 121 a real-time feed of the user's social network activities. For example, dynamic visual replay program 123 captures and formats the real-time feed in a screencast, a screen recorder, a video, a movie, or other dynamic visual media format. In this case, dynamic visual replay program 123 is configured to record or capture user account activities as a continuous record or file of the user account activities once the user logs off until the user logs back on SNS 121. In various embodiments, dynamic visual replay program 123 instructs or includes a command for SNS 121 to include a marker, a flag, or a timestamp for each user account activity occurring in dynamic visual display. In another embodiment, SNS 121 is configured capture the real-time feed of the logged off user account activities and format the user account activities as if they were to be displayed in a screencast, a screen recording, a video, or another type of dynamic visual media and sends file of the captured real-time feed to user account log 128.

Dynamic visual replay program 123 receives a notification the user signed on (208). When the user signs back on SNS 121, dynamic visual replay program 123 receives from SNS 121 a notification that the user is logged on.

In response to receiving notification the user has logged on, dynamic visual replay program 123 completes retrieval of the user account activity while the user was logged off (210). Dynamic visual replay program 123 completes user account activity retrieval by retrieving activities that might have occurred between the last retrieval and when the user logs back on SNS 121. In on embodiment, dynamic visual replay program 123 retrieves the activities that occurred in the user's social network in SNS 121 while the user is logged off SNS 121 when a request is received from the user. For example, the data on the user account activities occurring when the user is logged off SNS 121 are not retrieved until the user requests from a command line, an icon, a popup screen, or other method of inputting a command to dynamic visual replay program 123 requesting a file for video or another dynamic visual replay of the activities occurring in the logged off user's social network.

In some embodiments, dynamic visual replay program 123 retrieves the user social network activity occurring while the user is logged off SNS 121 once when the user signs back on SNS 121. For example, when the logged off user signs back on SNS 121, dynamic visual replay program 123 retrieves from user account log 128 activity occurring within the user's social network account. Each user account activity such as a post, a message, or a like occurring in the user's account in SNS 121 is sent to user account log 128 and stored in a discreet file with a timestamp corresponding to receipt by the user's account in SNS 121. In another embodiment, dynamic visual replay program 123 completes the retrieval of the activities occurring in the user's social network while the user is logged off by requesting or sending a command to SNS 121 to terminate or end the real-time feed of user account activity or activities occurring in the user's social network.

Upon retrieving or receiving the data on the activities occurring in the user's social network while logged off, dynamic visual replay program 123 creates a file for a dynamic visual replay of the activities occurring in the user's social network while logged off (212).

In various embodiments, dynamic visual replay program 123 creates a dynamic visual replay display of a user account activity while logged off by compiling the individual static files of each activity occurring in the user's social network into a single file for dynamic display of the user account activities. For example, dynamic visual replay program 123 creates a file such as a screen show, a video file, a screencast file, a screen recorder file, a visual media file, or another type of file for a dynamic visual review of the activities that occur in the user's social network while the user is logged off SNS 121.

In some embodiments, dynamic visual replay program 123 creates the individual static files of the retrieved files of user account activities (e.g., retrieved from user account log 128) using an application or program such as screen shot, screen recorder, or other method of displaying of a user activity such as a post or like. Dynamic visual replay program 123 creates a discreet file or the individual static file of each activity formatted for display by the applications such as screen shot or screen recorder. In an embodiment, dynamic visual replay program 123 stores the individual static files of each activity that occurs when the user is not logged on SNS 121 in a database or persistent memory. For example, dynamic visual replay program 123 stores to individual files in one of persistent memory of server 120, social network database 125, another database on server 120, or a database or memory on another computing device.

In various embodiments, dynamic visual replay program 123 compiles the individual static files of each user activity occurring while the user is logged off (e.g., posts, likes, links, and comments) in the order received by SNS 121 using the timestamps. For example, dynamic visual replay program 123 using an application or program such as screencast, screen recorder, a built-in video record function, or another method of creating a dynamic visual media file for a dynamic visual review or video replay, compiles the discreet files into a screen show, a screen cast, a video, or another visual media file type. In an embodiment, the files of each user activity are compiled in the order received by user account log 128 when user account log 128 stored the received activities in the order received by SNS 121 (e.g., without using timestamps). The compiled dynamic visual media file can display a dynamic visual replay or video replay of activities occurring in the logged off user's social network (e.g., compiles each individual activity occurring into a file for video display). For example, while the user is logged off, the user's account may receive a notice that “Sally” posted a new family photograph at 10 am Tuesday, “Jim” posted a comment on a new restaurant 6 pm Tuesday, and “Sue” liked Sally's photograph at 7 pm Tuesday. In this example, dynamic visual replay program 123 would create or compile a file to display dynamically such activity with a screen show or a video using each individual static file or discreet file. For example, a discreet file of Sally's post with a 10 am timestamp is formatted for display (e.g., the post captured or retrieved from user account log 128 and formatted in a discreet file or screen shot for display) is followed by the file or screen shot of Jim's restaurant comment displayed with a 6 pm timestamp, which is followed by a display or screen shot of Sue's like displayed with a 7 pm timestamp in the compiled file.

While each user account activity may be created by dynamic visual replay program 123 as an individual static file for display, the static files are compiled together by dynamic visual replay program 123 for dynamic visual or video replay. Dynamic visual replay program 123 may compile the individual static files of Sally's post, Jim's comment, and Sue's like into a file for a dynamic visual display or a video of the user account activities using a screencast, a screen recorder, or another application. For example, the compiled file may be a file for a screen show or a video of the post, the comment, and the like in the sequence that they were received by SNS 121. In an embodiment, the activity occurring within the user's account while the user is logged off may be recorded and presented in a list format, such list indicating the activity and the time, for example, “Jim posted a comment at 6 pm”.

In an embodiment, dynamic visual replay program 123 compiles a file that includes the user social network activities without including or showing the inactive or “dead time” between received activities such as posts, comments, or likes. Dynamic visual replay program 123 compiles the individual static files of each user activity in the sequence the activities occurred into single file such as a screen show, a screen cast, a screen recording, a video or other dynamic visual media for a dynamic visual replay or video of the activities occurring in a logged off user's social network. In some embodiments, the timestamp of the activity occurred or was received by the user's account in SNS 121 is displayed in the formatted discreet file and the compiled file for dynamic visual replay (e.g., video replay).

In various embodiments, dynamic visual replay program 123 may be configured to display each user account activity for a set period of time. For example, dynamic visual replay program 123 may be configured to show or display each user activity such as a post for ten seconds. Each user activity is displayed for a set period of time in the video or dynamic visual replay. The activity is displayed, as it would have appeared if the user were logged on to the social network, for example, SNS 121. When a user clicks on a link, the display of the compiled file is stopped or paused by dynamic visual replay program 123 while to user examines the linked data. When a link is selected, the user links to other websites, other data, or shared videos. Upon completing a review of the linked information, data, or website, the user returns to the file created by dynamic visual replay program 123 continues reviewing the user social network activities in the sequence that the activities occurred while logged off.

In one embodiment, dynamic visual replay program 123 includes an icon, a bar, or a button to increase speed of the video replay or the display of each user activity, to skip a display, to slow down the display of each activity or video replay, to pause the review of each user activity or video. In some embodiments, dynamic visual replay program 123 allows the user to pause the display of the user account activities and select a shared link.

In some embodiments, dynamic visual replay program 123 creates a file providing the user the ability to review or replay user social network activities occurring while logged off in a continuous dynamic visual display or format. The file for a continuous dynamic visual display would present or display the user's social network activities as if they had been logged on when the activities such as likes or posts were received by SNS 121.

In one embodiment, a continuous dynamic replay of missed social network activity is generated when dynamic visual replay program 123 receives from SNS 121 a real-time feed of the activity occurring in a logged of user's social network. For example, when dynamic visual replay program 123 receives a user selection of a continuous visual replay of activities that occurred when the user was logged off SNS 121, dynamic visual replay program 123 generates a command for SNS 121 to send a real-time feed of the user's social network account activities to dynamic visual replay program 123. The real-time feed is captured and formatted by dynamic visual replay program 123 in a form or file that is ready for dynamic visual display to the user. Dynamic visual replay program 123 may capture the real-time feed in a screencast, a screen recorder, or other dynamic visual media recorder. For example, dynamic visual replay program 123 may use an application or program such as a screencast, a screen recorder, or other application to create a visual media file for a dynamic visual display (e.g., a video replay, a screencast replay, or a movie) from the real-time feed of user account activities. In an embodiment, marker's, flags, timestamps, or other similar identification for browsing, fast forwarding, or moving the next activity within the file are embedded or formatted in the created file for a dynamic visual replay of a logged off user's social network activity. In some embodiments, dynamic visual replay program 123 provides the user ability to pause or stop the dynamic review (e.g., pause a video review) and link to data, files, photographs, videos and other electronic content utilizing the shared links provided by another user while the user is logged off.

Dynamic visual replay program 123 sends the file for a dynamic visual replay to the user (214). Dynamic visual replay program 123 sends the file created for a dynamic visual replay such as a video file or other visual media file of the social network activity on the user's account while the user is logged off SNS 121 to UI 133 on computer 130 or to one or more other computing devices (not shown in FIG. 1) for display to the user and the program ends.

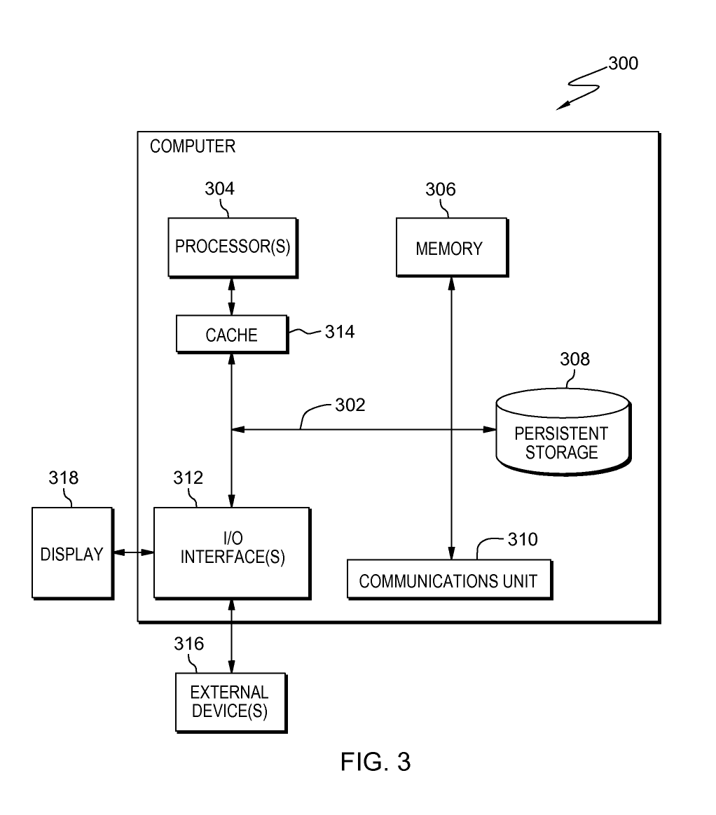

FIG. 3 depicts a block diagram 300 of components of a computer system, which is an example of a system such as server 120 within distributed data processing environment 100, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server 120 includes processor(s) 304, cache 314, memory 306, persistent storage 308, communications unit 310, input/output (I/O) interface(s) 312, and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention are stored in persistent storage 308 for execution and/or access by one or more of the respective processor(s) 304 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is part of persistent storage 308.

Communications unit 310, in these examples, provides for communications with other data processing systems or devices, including resources of server 120, computer 130, and other computing devices not shown in FIG. 1. In these examples, communications unit 310 includes one or more network interface cards. Communications unit 310 may provide communications with either or both physical and wireless communications links. Program instructions and data used to practice embodiments of the present invention may be downloaded to persistent storage 308 through communications unit 310.

I/O interface(s) 312 allows for input and output of data with other devices that may be connected to server 120. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media, for example, devices such as thumb drives, portable optical or magnetic disks, and memory cards. Software and data used to practice embodiments of the present invention can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

What is claimed is:

1. A method for creating a dynamic visual replay of one or more activities occurring in a user's social network, the method comprising:
receiving, by one or more computer processors, a command to create a file for a dynamic visual replay of one or more activities occurring in a user's social network, where the one or more activities occur while the user is logged off of the social network;
retrieving, by one or more computer processors, the one or more activities occurring while the user is logged off of the social network; and
creating, by one or more computer processors, the file for the dynamic visual replay of the one or more activities occurring while the user is logged off of the social network.

2. The method of claim 1, further comprises sending, by the one or more computer processors, the file for the dynamic visual replay to the user.

3. The method of claim 1, wherein retrieving, by one or more computer processors, the one or more activities occurring in the user's social network further comprises one or more of:
retrieving, by the one or more computer processors, one or more activities occurring in a set period of time in the user's social network from a database;
retrieving, by the one or more computer processors, one or more activities occurring when the user is logged off the social network when the user signs on to the social network;
receiving, by the one or more computer processors, a real-time feed of the one or more activities occurring in the user's social network; and
receiving, by one or more computer processors, a notification that the user signed on to the social network.

4. The method of claim 1, wherein retrieving, by one or more computer processors, the one or more activities occurring in the user's social network includes retrieving, by one or more computer processors, from a database a discreet file for each activity of the one or more activities occurring in the user's social network.

5. The method of claim 1, wherein creating, by one or more computer processors, the file for the dynamic visual replay of the one or more activities that occurred in the user's social network further comprises:
retrieving, by one or more computer processors, a discreet file for each user activity of the one or more activities that occur in the user's social network;
formatting, by one or more computer processors, for display a plurality of discreet files retrieved for the one or more activities that occur when the user is logged off; and
compiling, by one or more computer processors, the plurality of discreet files formatted for display into the file for the dynamic visual replay.

6. The method of claim 1, wherein creating by one or more computer processors, the file for the dynamic visual replay includes displaying, by one or more computer processors, within a displayed file, a time and a date associated with each of the one or more the user's account in the social network.

7. The method of claim 1, wherein creating, by one or more computer processors, the file for the dynamic visual replay of the one or more activities occurring in the user's social network further comprises:
sending, by one or more computer processors, a command to the social network to create a real-time feed of the one or more activities occurring in the user's social network;
receiving, by one or more computer processors, the real-time feed of the one or more activities occurring in the user's social network;
formatting, by one or more computer processors, the real-time feed for the dynamic visual replay; and
creating, by one or more computer processors, the file for the dynamic visual replay.

8. The method of claim 1, wherein creating, by one or more computer processors, the file for the dynamic visual replay of the one or more activities that occurred when the user is logged off the social network includes creating, by one or more computer processors, the file for at least one of: a screen show, a screencast, a video, and a movie.

9. A computer program product to create a dynamic visual replay of one or more activities occurring in a user's social network, the computer program product comprising:
one or more computer readable storage media and program instructions stored on the one or more computer readable storage media, the program instructions executable by a processor, the program instructions comprising:
program instructions to receive a command to create a file for a dynamic visual replay of one or more activities occurring in a user's social network, where the one or more activities occur while the user is logged off of the social network;
program instructions to retrieve the one or more activities occurring while the user is logged off of the social network; and
program instructions to create the file for the dynamic visual replay of the one or more activities occurring while the user is logged off of the social network.

10. The computer program product of claim 9, further comprises program instructions to send the file for the dynamic visual replay to the user.

11. The computer program product of claim 9, wherein retrieving the one or more activities occurring in the user's social network further comprises one or more of:
program instruction to retrieve one or more activities occurring in a set period of time in the user's social network from a database;
program instructions to retrieve one or more activities occurring when the user is logged off the social network when the user signs on to the social network;
program instructions to receive a real-time feed of the one or more activities occurring in the user's social network; and
program instructions to receive a notification that the user signed on to the social network.

12. The computer program product of claim 9, wherein creating the file for the dynamic visual replay of the one or more activities that occurred in the user's social network further comprises:
program instructions to retrieve a discreet file for each user activity of the one or more activities that occur in the user's social network;
program instructions to format for display a plurality of discreet files retrieved for the one or more activities that occur when the user is logged off; and
program instructions to compile the plurality of discreet files formatted for display into the file for the dynamic visual replay.

13. The computer program product of claim 9, wherein creating the file for the dynamic visual replay includes program instructions to display within a displayed file, a time and a date associated with each of the one or more activities the user's account in the social network.

14. The computer program product of claim 9, wherein creating the file for the dynamic visual replay of the one or more activities occurring in the user's social network further comprises:
program instructions to send a command to the social network to create a real-time feed of the one or more activities occurring in the user's social network;
program instructions to receive the real-time feed of the one or more activities occurring in the user's social network;
program instructions to format the real-time feed for the dynamic visual replay; and
program instructions to create the file for the dynamic visual replay.

15. The computer program product of claim 9, wherein creating the file for the dynamic visual replay of the one or more activities that occurred when the user is logged off the social network includes program instructions to create the file for at least one of: a screen show, a screencast, a video, and a movie.

16. A computer system to create a dynamic visual replay of one or more activities occurring in a user's social network, the computer system comprising:
one or more computer processors;
one or more computer readable storage media;
program instructions stored on the one or more computer readable storage media for execution by at least one of the one or more processors, the program instructions comprising:
program instructions to receive a command to create a file for a dynamic visual replay of one or more activities occurring in a user's social network, where the one or more activities occur while the user is logged off of the social network;
program instructions to retrieve the one or more activities occurring while the user is logged off of the social network; and
program instructions to create the file for the dynamic visual replay of the one or more activities occurring while the user is logged off of the social network.

17. The computer system of claim 16, further comprises program instructions to send the file for the dynamic visual replay to the user.

18. The computer system of claim 16, wherein retrieving the one or more activities occurring in the user's social network further comprises one or more of:
program instruction to retrieve one or more activities occurring in a set period of time in the user's social network from a database;
program instructions to retrieve one or more activities occurring when the user is logged off the social network when the user signs on to the social network;
program instructions to receive a real-time feed of the one or more activities occurring in the user's social network; and
program instructions to receive a notification that the user signed on to the social network.

19. The computer system of claim 16, wherein creating the file for the dynamic visual replay of the one or more activities that occurred in the user's social network further comprises:
program instructions to retrieve a discreet file for each user activity of the one or more activities that occur in the user's social network;
program instructions to format for display a plurality of discreet files retrieved for the one or more activities that occur when the user is logged off; and
program instructions to compile the plurality of discreet files formatted for display into the file for the dynamic visual replay.

20. The computer system of claim 16, wherein creating the file for the dynamic visual replay of the one or more activities occurring in the user's social network further comprises:
program instructions to send a command to the social network to create a real-time feed of the one or more activities occurring in the user's social network;
program instructions to receive the real-time feed of the one or more activities occurring in the user's social network;
program instructions to format the real-time feed for the dynamic visual replay; and
program instructions to create the file for the dynamic visual replay.
